(19) United States
(12) Patent Application Publication
(10) Pub. No.: US 2025/0074625 A1
(43) Pub. Date: Mar. 6, 2025

(54) SYSTEMS AND METHODS FOR MANUFACTURING STIFFENED COMPOSITE STRUCTURES

(71) Applicant: The Boeing Company, Arlington, VA (US)

(72) Inventor: Shawn S. Kim, Seattle, WA (US)

(21) Appl. No.: 18/460,420

(22) Filed: Sep. 1, 2023

(51) Int. Cl. B64F 5/10; B29C 70/68; B29C 70/70; B29C 70/84

(52) U.S. Cl. CPC B64F 5/10; B29C 70/682; B29C 70/70; B29C 70/84; B29L 2031/3085

(57) ABSTRACT

Systems and methods for manufacturing stiffened composite structures comprise a plurality of hollow airtight structures and curable material applied to outer surfaces of the plurality of hollow airtight structures. The plurality of hollow airtight structures are positioned in a predetermined arrangement relative to each other to define an assembly. The assembly is enclosed in a rigid outer mold and is cured within the rigid outer mold. After the assembly is cured, the plurality of hollow airtight structures and the curable material form the stiffened composite structure having an integrated internal stiffening structure.

### FIELD

The present disclosure relates to systems and methods for manufacturing composite structures having an integrated internal stiffening structure.

### BACKGROUND

Stiffened composite structures are structures that are constructed of composite materials, such as fiber reinforced composite materials, and typically include some form of internal structure that carries a skin. Various manufacturing techniques may be used to construct stiffened composite structures. For example, stiffened composite structures may be constructed by applying composite layups to a mold and vacuum-compacting and curing the skin in an autoclave.

This vacuum-compacting process is referred to in the aerospace industry as “bagging” and is both labor and time intensive and has several disadvantages. For one, utilizing the standard vacuum-compacting process to manufacture large parts (e.g., fuselages, wings, flaps, spoilers, etc.) requires large layup mandrels which are expensive to manufacture and require a large amount of factory space. Each layup mandrel has a specific shape and size that is configured to be utilized to form a specific part and the layup mandrels are not adaptable to new or updated designs. Thus, if a composite part with a different design is desired, a new layup mandrel must be manufactured. Additionally, forming complex parts using standard manufacturing methods often requires an assembly of multiple smaller parts to achieve the complex geometry. Furthermore, the vacuum-compacting process may require removal of portions of the mold from the composite part after curing which can result in damage to the cured composite part and adds additional assembly steps.

### SUMMARY

Methods of manufacturing composite structures comprise applying at least one layer of curable material to outer surfaces of a plurality of hollow airtight structures and positioning the plurality of hollow airtight structures in a predetermined arrangement relative to each other to define an assembly. Methods further comprise enclosing the assembly within a rigid outer mold and curing the assembly within the rigid outer mold.

### BRIEF DESCRIPTION OF THE DRAWINGS

FIG. 1 is a flowchart representing a method of manufacturing a composite structure.

FIGS. 2A and 2B are a schematic illustrations representing methods of manufacturing composite structures.

FIG. 3 is a schematic representation of a first illustrative internal stiffening structure of a composite structure in the form of a spoiler for an aircraft.

FIG. 4 is a schematic representation of a second illustrative internal stiffening structure of an optimized composite structure in the form of a second spoiler for an aircraft shown with a load map.

FIG. 5 is a representation of an example composite structure in the form of a third spoiler manufactured utilizing the methods of FIGS. 1-2B.

### DESCRIPTION

Systems and methods for manufacturing composite structures are disclosed. Generally, in the figures, elements that are likely to be included in a given example are illustrated in solid lines, while elements that are optional to a given example are illustrated in broken lines. However, elements that are illustrated in solid lines are not essential to all examples of the present disclosure, and an element shown in solid lines may be omitted from a particular example without departing from the scope of the present disclosure.

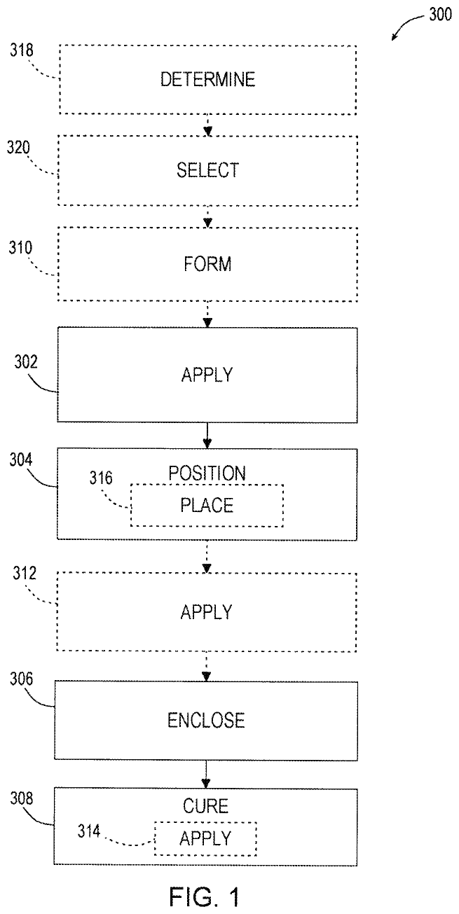

FIG. 1 schematically provides a flowchart that represents illustrative, non-exclusive examples of methods 300 according to the present disclosure. In FIG. 1, some steps are illustrated in dashed boxes indicating that such steps may be optional or may correspond to an optional version of a method according to the present disclosure. That said, not all methods according to the present disclosure are required to include the steps illustrated in solid boxes. The methods and steps illustrated in FIG. 1 are not limiting and other methods and steps are within the scope of the present disclosure, including methods having greater than or fewer than the number of steps illustrated, as understood from the discussions herein.

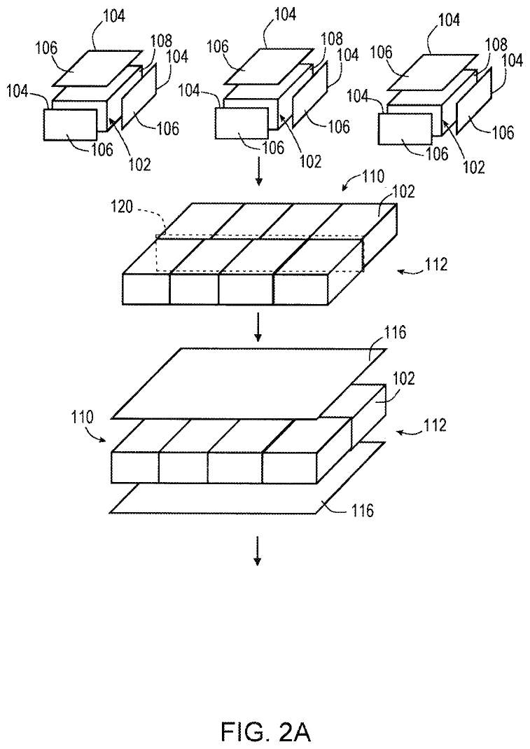

FIGS. 2A-2B schematically provide a representation of certain steps of the methods 300 of manufacturing composite structures 100, represented in FIG. 1. The examples of FIGS. 2A-2B are non-exclusive and do not limit the methods 300 to the illustrated embodiments of FIGS. 2A-2B. That is, the methods 300 are not limited to the steps illustrated in FIG. 2A-2B and the methods 300 may incorporate any number of the various aspects, configurations, characteristics, properties, etc. of the methods 300 that are illustrated in and discussed with reference to the schematic representation of FIG. 1, as well as variations thereof, without requiring the inclusion of all such aspects, configurations, characteristics, properties, etc.

Methods 300 of manufacturing composite structures 100 comprise applying 302 at least one layer 104 of curable material 106 to outer surfaces 108 of a plurality of hollow airtight structures 102. In some examples, applying 302 comprises completely covering each outer surface 108 of each of the plurality of hollow airtight structures 102 with the curable material 106. In some examples, portions of one or more of the outer surfaces 108 of one or more of the hollow airtight structures are not covered by the curable material 106. The at least one layer 104 of curable material 106 may comprise a fiber-reinforced composite material (e.g., a pre-preg composite material) and/or any other suitable material. In some examples, the at least one layer 104 of curable material 106 is applied to each outer surface 108 of each of the plurality of hollow airtight structures 102. In some examples, more than one layer of the curable material 106 is applied to one or more of the outer surfaces 108 of the plurality of hollow airtight structures 102.

The plurality of hollow airtight structures 102 may include any suitable number of hollow airtight structures 102 and each of the hollow airtight structures 102 may have any suitable size and/or shape. For example, one or more of the hollow airtight structures 102 may comprise a planar-faced prism (e.g., a six-sided prism, a cube, a rectangular prism, etc.). Each of the plurality of hollow airtight structures 102 may be identical to each other or one or one or more of the hollow airtight structures 102 may have a different size and/or shape than the other hollow airtight structures 102. In some examples, the plurality of hollow airtight structures 102 comprise a material that is deformable when heated. For example, the plurality of hollow airtight structures 102 may comprise an Acrylonitrile Butadiene Styrene (ABS) plastic material and/or any other suitable plastic material.

Methods 300 of manufacturing composite structures 100 comprise positioning 304 the plurality of hollow airtight structures 102 in a predetermined arrangement 110 relative to each other to define an assembly 112. In some examples, the predetermined arrangement 110 is determined based on an intended internal stiffening structure of the composite structure 100 being manufactured. For example, the plurality of hollow airtight structures 102 may be arranged such that when cured the curable material 106 applied to the outer surfaces 108 of the hollow airtight structures 102 forms the desired internal stiffening structure of the composite structure 100.

In the schematic example shown in FIG. 2A, eight hollow airtight structures 102 are positioned in the predetermined arrangement 110 to define the assembly 112. The hollow airtight structures 102 are positioned in two adjacent rows of four. In some examples, each hollow airtight structure 102 is positioned adjacent one or more of the other hollow airtight structures 102, such that the curable material 106 applied to the outer surfaces 108 of each of the hollow airtight structures 102 contacts the curable material 106 applied to the outer surfaces 108 of one or more adjacent hollow airtight structures 102. FIG. 2A depicts one possible predetermined arrangement 110, however the plurality of hollow airtight structures 102 may be positioned in any suitable predetermined arrangement 110 dependent on the desired internal structure of the composite structure 100.

In some examples, methods 300 comprise placing 316 a plate 120 adjacent the plurality of hollow airtight structures 102 positioned in the predetermined arrangement 110. In some examples, the placing 316 the plate 120 comprises placing the plate 120 between at least two adjacent hollow airtight structures 102 positioned in the predetermined arrangement 110. The plate 120 is configured to provide increased stiffness and/or support at a predetermined position of the assembly 112. For example, the plate 120 may be positioned proximate a mid spar and/or any other suitable position of the composite structure 100 that is expected to be subjected to high loads. In some examples, one or more layers of curable material 106 (e.g., carbon fiber reinforced plastic (CFRP)) are applied onto the outer surfaces of the plate 120. The plate 120 may be planar, non-planar (e.g., I-shaped, C-shaped, or Z-shaped, and/or may have any other suitable shape and/or size dependent on the composite structure 100 being manufactured. The plate 120 may comprise any suitable material configured to facilitate adhesion of the curable material 106 to the plate 120 during the curing cycle. In some examples, the plate 120 comprises a material that is configured to remain rigid during a composite curing cycle. The plate 120 may comprise a metal (e.g., titanium), a composite (e.g., thermoplastic composite), and/or any other suitable material configured to maintain an intended design shape and/or strength of the plate 120.

As shown in the example of FIG. 2A, the plate 120 is placed between the two rows of four hollow airtight structures 102 positioned in the predetermined arrangement 110. In this example, the plate 120 is positioned to form a continuous mid spar of the composite structure 100 being manufactured. As described above, the plate 120 may have one or more layers of curable material 106 applied to the outer surface of the plate 120. After curing, the one or more layers of the curable material 106 applied to the plate 120 may combine with the one or more layers of the curable material 106 applied to the outer surfaces 108 to increase the strength of the mid spar. The plate 120 is configured to maintain shape during a curing process and provides a continuous surface for the curable material 106 to be cured to.

In some examples, the plate 120 is positioned at a front of the assembly or rear of the assembly to provide support at a front or rear spar of the composite structure 100. In some examples, multiple plates 120 are placed between one or more adjacent hollow airtight structures 102 positioned in the arrangement 110. Any suitable number of plates 120 may be placed in the predetermined arrangement 110, and the plates 120 may be positioned at any suitable position of the arrangement 110.

In some examples, methods 300 comprise applying 312 at least one skin 116 of the curable material 106 to the assembly 112. For example, as shown in FIG. 2A, the at least one skin 116 of the curable material 106 may comprise one or more skins of the curable material 106 applied to an upper surface and/or a lower surface of the assembly 112. In some examples, the at least one skin 116 of the curable material 106 is applied only to a lower surface or only to an upper surface of the assembly 112. As described above, the curable material 106 may comprise a fiber-reinforced composite material (e.g., a pre-preg composite material) and/or any other suitable material. In some examples, the applying 312 the at least one skin 116 of the curable material 106 to the assembly 112 occurs after the positioning 304 of the plurality of hollow airtight structures and/or the placing 316 of the plate 120, but prior to enclosing 306 the assembly 112, as described further below.

As shown in FIG. 2B, methods 300 of manufacturing composite structures 100 comprise enclosing 306 the assembly 112 within a rigid outer mold 114. The rigid outer mold 114 may comprise any suitable rigid structures configured to enclose the assembly 112 and configured to remain rigid during a composite curing cycle. In some examples, the rigid outer mold 114 has an inner shape or inner contour that matches a desired outer shape or contour of the composite structure 100.

Methods 300 of manufacturing composite structures 100 comprise curing 308 the assembly 112 within the rigid outer mold 114. In some examples, the curing 308 the assembly 112 within the rigid outer mold 114 comprises enclosing the rigid outer mold 114 in a vacuum bag and applying a vacuum on the assembly 112 and rigid outer mold 114 within the vacuum bag. The assembly 112 enclosed in the rigid outer mold 114 and within the vacuum bag may then be placed in a curing oven or an autoclave.

In some examples, the curing 308 of the assembly 112 comprises applying 314 heat to the rigid outer mold 114 and the assembly 112. For example, as described above, the rigid outer mold 114 enclosing the assembly 112 may be placed in an autoclave or curing oven which applies heat to the rigid outer mold 114 and the assembly 112. The applying 314 heat to the rigid outer mold 114 and the assembly 112 causes air within the plurality of hollow airtight structures 102 to expand. In some examples, the plurality of hollow airtight structures 102 comprise a material that is deformable when heated, such that the air within the plurality of hollow airtight structures 102 causes the plurality of hollow airtight structures 102 to expand. The outward expansion of the hollow airtight structures 102 in response to the applying 314 heat, generates an outward pressure on the curable material 106 applied to the outer surfaces 108 of the plurality of hollow airtight structures 102. As a result, the curable material 106 is pushed outward and compacted against the rigid outer mold 114, the plurality of hollow airtight structures 102, and optionally the plate 120.

As shown in FIG. 2B, after the curing 308 the assembly 112 within the rigid outer mold 114, the composite structure 100 is formed and the rigid outer mold 114 is removed from the composite structure 100. The cured curable material 106′ forms an internal stiffening structure of the composite structure 100. For example, the cured curable material 106′ may form a plurality of ribs and/or spars of the composite structure 100. In some examples, the cured skins 116′ form upper and lower skins of the structure 100 sandwiching the assembly 112′. After the curing 308, the plurality of hollow airtight structures 102′ are configured to remain within the composite structure 100. Due to the plurality of hollow airtight structures 102′ being hollow, the hollow airtight structures 102′ are generally lightweight and comprise a “flyaway” tooling of the composite structure 100.

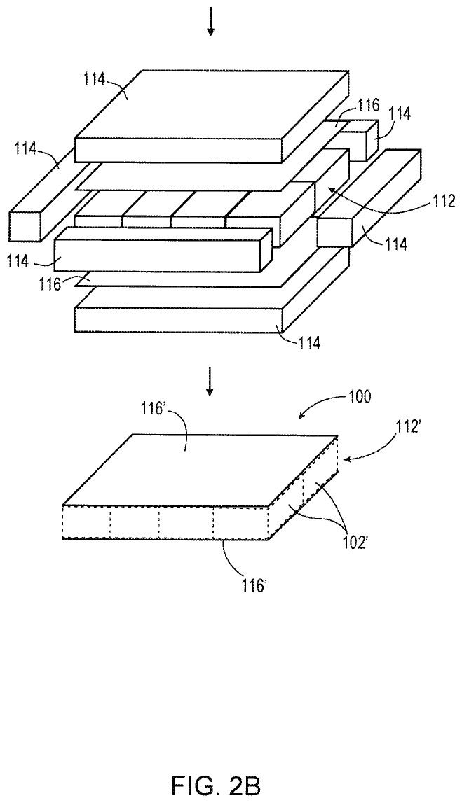

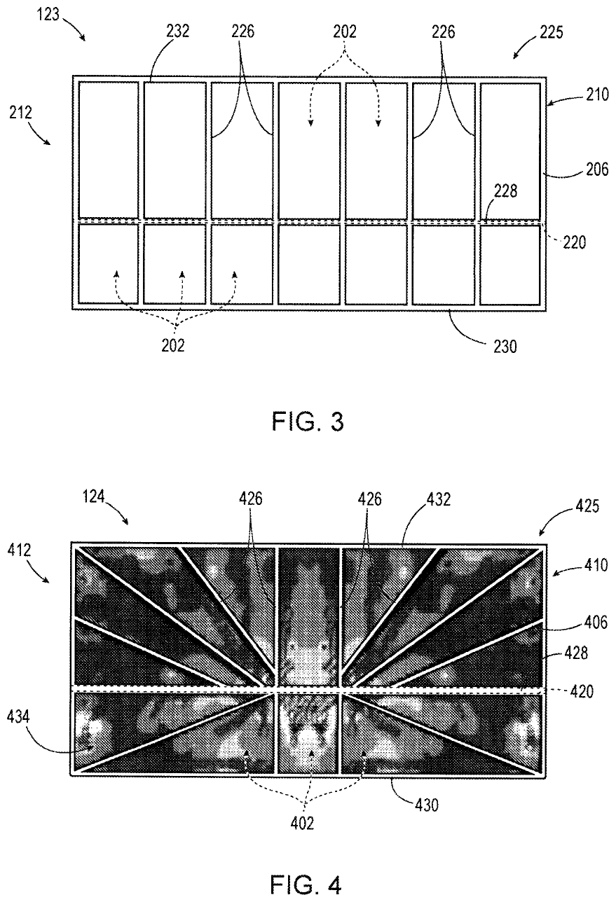

In some examples, methods 300 comprise, prior to the applying 302 the at least one layer 104 of curable material 106, determining 318 an internal stiffening structure 123 (FIG. 3) of the composite structure 100. In some examples, the determining 318 comprises determining an optimal internal stiffening structure 124 (FIG. 4) for the particular composite structure 100 that is being manufactured. For example, the determining 318 the optimal internal stiffening structure 124 may include determining an optimal position and/or arrangement of one or more spars 428, 430, 432 and/or ribs of the optimal internal stiffening structure 124 to maximize the strength and integrity of the composite structure 100. In some examples, one or more software applications are utilized to determine which regions of the composite structure 100 are expected to be subjected to the greatest forces or loads. Based on the determined high-load regions of the composite structure 100, the optimal position for the spars and/or ribs of the internal stiffening structure may be determined. The optimal internal stiffening structure 124 may be dependent on the type of composite structure 100 (e.g., a spoiler, a flap, an aileron, etc.), the intended size and/or planform of the composite structure 100, and/or any other suitable factors.

In some examples, methods 300 of manufacturing composite structures 100 comprise, following the determining 318 of the internal stiffening structure and prior to the applying 302, selecting 320 a plurality of hollow airtight structures 102 based on the internal stiffening structure. For example, each of the hollow airtight structures 102 may be selected based on the respective size and shape of the internal stiffening structure. In some examples, the selected plurality of hollow airtight structures 102 are configured to be arranged relative each other, such that the curable material 106 applied to the outer surfaces 108 of the hollow airtight structures 102 forms an approximation of the internal stiffening structure of the composite structure 100 after the curing 308.

In some examples, methods 300 of manufacturing composite structures 100 include forming 310 the plurality of hollow airtight structures 102. The plurality of hollow airtight structures 102 may be formed to have any suitable size and/or shape dependent on the internal stiffening structure of the composite structure 100. For example, one or more of the hollow airtight structures 102 may comprise any suitable planar-faced prism (e.g., a six-sided prism, a cube, a rectangular prism, etc.). The plurality of hollow airtight structures 102 may be formed from any suitable material that is deformable when heated, such that air within the plurality of hollow airtight structures 102 causes the plurality of hollow airtight structures 102 to expand when heated. For example, the plurality of hollow airtight structures 102 may comprise an ABS plastic material and/or any other suitable plastic material.

Methods 300 are configured to facilitate manufacturing composite structures 100 that have any suitable internal stiffening structure 123, 124 including complex internal stiffening structures. The hollow airtight structures 102 utilized in the methods 300 are relatively inexpensive to manufacture and facilitate manufacturing composite structures 100 having any suitable internal stiffening structures 123, 124. For example, by selecting 320, forming 310, and/or utilizing hollow airtight structures 102 having different sizes and/or shapes and by arranging the plurality of hollow airtight structures in different predetermined arrangements 110, any suitable internal stiffening structure 123, 124 may be formed. When at room temperature, the plurality of hollow airtight structures 102 are configured to function as a rigid tooling for applying the at least one skin 116 of the curable material 106 onto. When heated, the plurality of hollow airtight structures 102 are configured to expand to compact the curable material 106 against the other hollow airtight structures 102, the rigid outer mold 114, and optionally the plate 120. After the curing 308, the plurality of hollow airtight structures 102 are a lightweight flyaway tooling that does not require extraction from the formed composite structure 100. In this manner, the hollow airtight structures 102 facilitate a relatively low-cost method of manufacturing any wide variety of different composite structures 100, such as a wing, spoiler, flap, aileron, and/or any other suitable aerospace component. Composite structures 100 with complex geometries may be formed using methods 300 by arranging the plurality of hollow airtight structures in different predetermined arrangements 110.

With continued reference to FIGS. 3-4, illustrative non-exclusive examples of internal stiffening structures 123, 124 of composite structures 100 in the form of spoilers 225, 425 for an aircraft are illustrated. The examples of FIGS. 3-4 are non-exclusive and do not limit the internal structures of composite structures 100 to the illustrated embodiments of the internal stiffening structures 123, 124. That is, the internal stiffening structures of composite structures 100 are not limited to the specific embodiments of the illustrated internal stiffening structures 123, 124, and the internal stiffening structures of composite structures 100 may incorporate any number of the various aspects, configurations, characteristics, properties, etc. of the composite structures 100 that are illustrated in and discussed with reference to the schematic representations of FIGS. 1-2, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to the internal stiffening structures 123, 124; however, it is within the scope of the present disclosure that the previously discussed features, variants, etc. may be utilized with the internal stiffening structures 123, 124.

FIG. 3 illustrates an example of an internal stiffening structure 123 of a first spoiler 225 for an aircraft. The internal stiffening structure 123 of spoiler 225 is a non-limiting example of the internal stiffening structures of composite structures 100 manufactured using methods 300, described above.

As shown in FIG. 3, the internal stiffening structure 123 comprises a front spar 230, a mid spar 228, a rear spar 232, and a plurality of ribs 226. The spars 228, 230, 232 and the plurality of ribs 226 are configured to provide support and stiffness to the spoiler 225. The front spar 230, the mid spar 228, and the rear spar 232 extend horizontally across the spoiler 225 and the plurality of ribs 226 extend transverse to the spars 228, 230, 232 across the spoiler 225. In this example, the plurality of ribs 226 extend from the rear spar 232 to the mid spar 228 and from the front spar 230 to the mid spar 228. In some examples, internal stiffening structure 123 may not comprise a mid spar 228 and the plurality of ribs 226 may extend from the front spar 230 to the rear spar 232.

As shown in FIG. 3, the front spar 230, the mid spar 228, the rear spar 232, and the plurality of ribs 226 may be formed between adjacent surfaces of a plurality of hollow airtight structures 202. The hollow airtight structures 202 are an example of hollow airtight structures 102, described above with reference to FIGS. 2A-2B. In other words, the plurality of hollow airtight structures 202 may be disposed between the spars 228, 230, 232 and the plurality of ribs 226. The front spar 230, the mid spar 228, the rear spar 232, and the plurality of ribs 226 are formed of a curable material 206 (e.g., pre-preg composite) that is cured during the manufacturing of the spoiler 225, as described above with reference to methods 300.

The plurality of hollow airtight structures 202 may be arranged in a predetermined arrangement 210. In the schematic illustration of FIG. 3, the hollow airtight structures 202 comprise rectangular prisms of different sizes and the hollow airtight structures are positioned in two adjacent rows. However, each of the hollow airtight structures 202 may comprise any suitable shape and/or size and may be arranged in any suitable predetermined arrangement 210 dependent on the specific composite structure. For example, spoilers for aircrafts may have a generally tapered profile, and one or more of the plurality of hollow airtight structures may comprise a trapezoidal prism, as an example. Each of the plurality of hollow airtight structures 102 may comprise a trapezoidal prism, rhombic prism, rectangular prism and/or any other suitable planar faced prism. The plurality of hollow airtight structures 202 comprise “flyaway” tooling of the spoiler 225. In other words, the plurality of hollow airtight structures 202 are configured to remain within the spoiler 225 following manufacturing thereof.

As shown in FIG. 3, in some examples, the internal stiffening structure 123 comprises a plate 220 positioned adjacent to the mid spar 228 of the internal stiffening structure 123. The plate 220 is configured to provide support and stiffness to the mid spar 228 of the spoiler 225. Alternatively, or additionally, a plate 220 may be positioned adjacent the front spar 230, the rear spar 232, the one or more the ribs 226, and/or any other suitable position between any two adjacent hollow airtight structures 202. Any suitable number of plates 220 may be utilized to form portions of the internal stiffening structure 123. The plate 220 may comprise a metal (e.g., titanium), a non-metal (e.g., thermoplastic composite), and/or any other suitable material configured to provide the support and stiffness to the mid spar 228.

FIG. 3 depicts one possible arrangement 210 of the plurality of hollow airtight structures 202. However, any suitable number of the hollow airtight structures 202 may be utilized and the plurality of hollow airtight structures may be positioned in any suitable arrangement dependent on the desired positioning of the ribs 226 and the spars 228, 230, 232. The hollow airtight structures 202 may have any suitable size and shape dependent on the desired internal stiffening structure 123. The hollow airtight structures 202 are an example of the hollow airtight structures 102, described above with reference to FIGS. 1-2B.

The spoiler 225 having the internal stiffening structure 123 may be manufactured using methods 300, described above with reference to FIGS. 1 and 2. For example, one or more layers of a curable material (e.g., the curable material 106 described above with reference to FIGS. 2A-2B) are applied to the outer surfaces of the plurality of hollow airtight structures 202. The plurality of hollow airtight structures 202 are then positioned in the predetermined arrangement 210 to define an assembly 212. In this example, the predetermined arrangement 210 comprises two adjacent rows of the plurality of hollow airtight structures 202. In some examples, the plate 220 is placed between the two adjacent rows of the plurality of hollow airtight structures 202 proximate the mid spar 228. In some examples, at least one skin of the curable material is applied to the assembly 212. For example, a first skin of the curable material may be applied to an upper surface of the assembly 212, and a second skin of the curable material may be applied to a lower surface of the assembly 212. The assembly 212 is then enclosed in a rigid outer mold and the assembly 212 is cured within the rigid outer mold. After the curing of the assembly 212, the internal stiffening structure 123 is formed from the cured curable material 206. In some examples, the skins of the cured curable material 206 applied to the upper and lower surfaces of the assembly 212 form an upper surface and a lower surface of the spoiler 225 with the internal stiffening structure 123 sandwiched between.

FIG. 4 illustrates an example of a second internal stiffening structure 124 (i.e., an optimal internal stiffening structure 124) of a second spoiler 425. The second internal stiffening structure 124 of the second spoiler 425 is a non-limiting example of internal stiffening structures of composite structures 100 manufactured using methods 300, described above.

The second internal stiffening structure 124 of the spoiler 425 is based on a structural optimization of the internal stiffening structure for the spoiler 425 and is configured to approximate an optimal internal stiffening structure of the spoiler 425. For example, software may be utilized to determine a load map 434 indicating the regions of the second internal stiffening structure 124 that are expected to be subjected to the largest forces or loads. In FIG. 4, darker regions of the load map 434 correspond to regions of the internal stiffening structure 124 that are expected to be subjected to greater loads, whereas lighter regions of the load map 434 correspond to regions that are expected to be subjected to lesser loads. The second internal stiffening structure 124 comprises a front spar 430, a mid spar 428, a rear spar 432, and a plurality of ribs 426 that are positioned and orientated to generally correspond to the regions of the spoiler 425 that are expected to be subjected to the largest loads (e.g., the darker regions of the load map 434). The spars 428, 430, 432 and the plurality of ribs 426 provide added structural support and stiffness at the high-load regions of the spoiler 425.

Methods 300 of manufacturing composite structures 100 facilitate manufacturing the spoiler 425 having the second internal stiffening structure 124 that approximates an optimal stiffening structure for the spoiler 425. For example, a method of manufacturing the spoiler 425 may comprise determining the optimal internal stiffening structure for the spoiler 425 by utilizing one or more software applications to generate the load map 434 indicating the regions of the internal stiffening structure 124 that are expected to be subjected to the greatest loads. A plurality of hollow airtight structures 402 are selected or formed based on the determined optimal internal stiffening structure for the spoiler 425. At least one layer of a curable material (e.g., the curable material 106 described above) is applied to the outer surfaces of the plurality of hollow airtight structures 402 and the plurality of hollow airtight structures 402 are positioned in a predetermined arrangement 410 to define an assembly 412. In some examples, a plate 420 is positioned proximate the mid spar of the spoiler 425 to provide additional structural support at the mid spar. In some examples, at least one skin of the curable material is applied to the upper and/or lower surfaces of the assembly 412. The assembly is then cured within a rigid outer mold. After curing, the cured curable material 406 and optionally the plate 420 collectively form the internal stiffening structure 124. The plurality of hollow airtight structures 402 remain within the internal stiffening structure 124 of the spoiler 425 as a “flyaway” tooling.

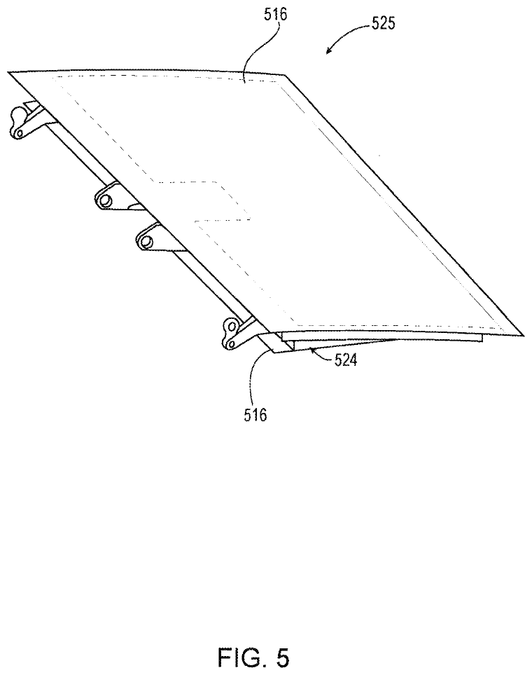

The optimal internal stiffening structure for each specific composite structure 100 may be dependent on the type of composite structure 100 (e.g., a spoiler, a flap, an aileron, etc.), the intended size and/or planform of the composite structure 100, and/or any other suitable factors. FIG. 4 illustrates one possible arrangement of the plurality of hollow airtight structures 402, the spars 428, 430, 432, and the plurality of ribs 426 forming the second internal stiffening structure 124 of the spoiler 425. However, methods 300 facilitate manufacturing a multitude of different composite structures having any suitable internal stiffening structure. For example, methods 300 may be utilized to manufacture a wing, spoiler, flap, aileron, and/or any other suitable aerospace component or flight control component. By changing the number, size, shape, and/or arrangement of the hollow airtight structures 102, 202, 402 utilized in the methods 300, any suitable internal stiffening structure for the aerospace component and/or the flight control component may be formed. With reference to FIG. 5, an illustrative non-exclusive example of composite structures 100 in the form of a spoiler 525 for an aircraft is illustrated. The spoiler 525 includes an upper and lower skin layer 516 sandwiching a core structure 524. In some examples, the core structure 524 of the spoiler 525 includes an internal stiffening structure substantially similar to the internal stiffening structure 123 or the optimized internal stiffening structure 124, described above with reference to FIGS. 3 and 4. For example, the core structure 524 may include one or more ribs and/or spars configured to provide structural support to the upper and lower skin layers 516 of the spoiler. The spoiler 525 is a non-limiting example of composite structures 100 manufactured utilizing methods 300, described above with reference to FIGS. 1-2B.

Illustrative, non-exclusive examples of inventive subject matter according to the present disclosure are described in the following enumerated paragraphs:
A. A method (300) of manufacturing a composite structure (100), the method (300) comprising:
   applying (302) at least one layer (104) of curable material (106) to outer surfaces (108) of a plurality of hollow airtight structures (102);
   positioning (304) the plurality of hollow airtight structures (102) in a predetermined arrangement (110) relative to each other to define an assembly (112);
   enclosing (306) the assembly (112) within a rigid outer mold (114); and
   curing (308) the assembly (112) within the rigid outer mold (114).
A1. The method (300) of paragraph A, further comprising forming (310) the plurality of hollow airtight structures (102).
A2. The method (300) of any one of paragraphs A-A1, wherein one or more of the hollow airtight structures (102) comprise an ABS plastic material.
A3. The method (300) of any one of paragraphs A-A2, wherein the at least one layer (104) of curable material (106) comprises a fiber-reinforced composite material.
A3.1. The method (300) of paragraph A3, wherein the fiber-reinforced composite material comprises a pre-preg composite material.
A4. The method (300) of any one of paragraphs A-A3.1, further comprising:
   following the positioning (304) and prior to the enclosing (306), applying (312) at least one skin (116) of the curable material (106) to the assembly (112).
A5. The method (300) of any one of paragraphs A-A4, wherein one or more of the hollow airtight structures (102) comprise a planar-faced prism.
A6. The method (300) of any one of paragraphs A-A5, wherein one or more of the hollow airtight structures (102) comprise a six-sided prism.
A7. The method (300) of any one of paragraphs A-A6, wherein the curing (308) the assembly (112) comprises applying (314) heat to the rigid outer mold (114) and the assembly (112).
A7.1. The method (300) of paragraph A7, wherein the applying (314) heat to the rigid outer mold (114) and the assembly (112) causes air within the plurality of hollow airtight structures (102) to expand outward against adjacent structure within the rigid outer mold (114).
A7.1.1. The method (300) paragraph A7.1, wherein each of the hollow airtight structures (102) is deformable when heated, such that the air within the plurality of hollow airtight structures (102) causes the plurality of hollow airtight structures (102) to expand.
A8. The method (300) of any one of paragraphs A-A7.1.1, wherein the positioning (304) comprises placing (316) a plate (120) between at least two adjacent hollow airtight structures (102).
A8.1. The method (300) of paragraph A8, wherein the plate (120) comprises metal.
A8.2. The method (300) of paragraph A8 or A8.1, wherein the plate (120) comprises titanium.
A8.3. The method (300) of paragraph A8, wherein the plate (120) comprises a non-metal.
A8.4. The method (300) of paragraph A8 or A8.3, wherein the plate (120) comprises a thermoplastic composite material.
A9. The method (300) of any one of paragraphs A-A8.4, further comprising, prior to the applying (302) the at least one layer (104) of the curable material (106), determining (318) an optimal internal stiffening structure (124) of the composite structure (100) based on a load map (434).
A9.1. The method (300) of paragraph A9, further comprising, following the determining (318) and prior to the applying (302) the at least one layer (104) of the curable material (106), selecting (320) the plurality of hollow airtight structures (102) based on the optimal internal stiffening structure (124).
A9.1.1. The method (300) of paragraph A9.1, wherein after the curing (308) the assembly (112), the curable material (106) applied to the outer surfaces (108) of the plurality of hollow airtight structures (102) forms an approximation of the optimal internal stiffening structure (124) based on the load map (434).
A10. The method (300) of any one of paragraphs A-A9.1.1, wherein the composite structure (100) comprises an aerospace component.
A11. The method (300) of any one of paragraphs A-A10, wherein the composite structure (100) comprises a flight control structure.
A12. The method (300) of any one of paragraphs A-A11, wherein the composite structure (100) comprises a spoiler (225, 425).
A12.1. The method (300) of paragraph A12, wherein after the curing (308) the assembly (112), the curable material (106) forms at least one rib (226, 426), a mid spar (228, 428), and a front spar (230, 430) of the spoiler (225, 425).
B. A system for manufacturing a composite structure (100), the system comprising:
   at least one layer (104) of curable material (106) applied to outer surfaces (108) of a plurality of hollow airtight structures (102); the plurality of hollow airtight structures (102) positioned relative to each other in a predetermined arrangement (110) defining an assembly (112);
   at least one skin (116) of the curable material (106) applied to the assembly (112); and
   a rigid outer mold (114) enclosing the assembly (112) and the at least one skin (116).
B1. The system of paragraph B, wherein the at least one layer (104) of the curable material (106) comprises a fiber-reinforced composite material.
B1.1. The system of paragraph B1, wherein the at least one layer (104) of the curable material (106) comprises a pre-preg composite material.
B2. The system of any one of paragraphs B-B1.1, further comprising a plate (120) positioned between at least two adjacent hollow airtight structures (102).
B2.1. The system of paragraph B2, wherein the plate (120) comprises a metal.
B2.2. The system of paragraph B2 or B2.1, wherein the plate (120) comprises titanium.
B2.3. The system of paragraph B2, wherein the plate (120) comprises a non-metal.
B2.4. The system of paragraph B2 or B2.3, wherein the plate (120) comprises a thermoplastic composite material.
B3. The system of any one of paragraphs B-B2.4, wherein each hollow airtight structure (102) of the plurality of hollow airtight structures (102) is deformable when heated.
B4. The system of any one of paragraphs B-B3, wherein each hollow airtight structure (102) of the plurality of hollow airtight structures (102) comprises an ABS plastic material.
C. A stiffened composite structure (100), the stiffened composite structure (100) comprising:
   an internal stiffening structure (123, 124) including one or more spars (230, 228, 232, 430, 428, 432) extending horizontally across the composite structure (100) and one or more ribs (226, 426) extending transverse to the one or more spars (230, 228, 232, 430, 428, 432); and
   a plurality of hollow airtight structures (102, 202, 402) disposed between the spars (230, 228, 232, 430, 428, 432) and the one or more ribs (226, 426).
C1. The stiffened composite structure (100) of paragraph C, wherein the one or more spars (230, 228, 232, 430, 428, 432) comprise a front spar (230, 430), a mid spar (228, 428), and a rear spar (232, 432).
C1.1. The stiffened composite structure (100) of paragraph C1, wherein one or more of the one or more ribs (226, 426) extend between the front spar (230, 430) and the mid spar (228, 428), and one or more of the one or more ribs (226, 426) extend between the mid spar (228, 428) and the rear spar (232, 432).
C2. The stiffened composite structure (100) of any one of paragraphs C-C1.1, further comprising a first and a second skin (116) of the curable material (106), wherein the internal stiffening structure (123, 123) is disposed between the first and second skin (116) of curable material (106).

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A method of manufacturing a composite structure, the method comprising:
applying at least one layer of curable material to outer surfaces of a plurality of hollow airtight structures;
positioning the plurality of hollow airtight structures in a predetermined arrangement relative to each other to define an assembly;
enclosing the assembly within a rigid outer mold; and
curing the assembly within the rigid outer mold.

2. The method of claim 1, further comprising forming the plurality of hollow airtight structures.

3. The method of claim 1, wherein one or more of the plurality of hollow airtight structures comprise an ABS plastic material.

4. The method of claim 1, wherein the at least one layer of curable material comprises a fiber-reinforced composite material.

5. The method of claim 4, wherein the fiber-reinforced composite material comprises a pre-preg composite material.

6. The method of claim 1, further comprising:
following the positioning and prior to the enclosing, applying at least one skin of the curable material to the assembly.

7. The method of claim 1, wherein one or more of the plurality of hollow airtight structures comprise a planar-faced prism.

8. The method of claim 1, wherein one or more of the plurality of hollow airtight structures comprise a six-sided prism.

9. The method of claim 1, wherein the curing the assembly comprises applying heat to the rigid outer mold and the assembly.

10. The method of claim 9, wherein the applying heat to the rigid outer mold and the assembly causes air within the plurality of hollow airtight structures to expand.

11. The method of claim 10, wherein each hollow airtight structure of the plurality of hollow airtight structures is deformable when heated, such that the air within the plurality of hollow airtight structures causes the plurality of hollow airtight structures to expand outward against adjacent structure within the rigid outer mold.

12. The method of claim 1, wherein the positioning comprises placing a plate between at least two adjacent hollow airtight structures.

13. The method of claim 12, wherein the plate comprises a metal.

14. The method of claim 1, further comprising, prior to the applying the at least one layer of the curable material, determining an optimal internal stiffening structure of the composite structure based on a load map.

15. The method of claim 14, further comprising, following the determining and prior to the applying the at least one layer of the curable material, selecting the plurality of hollow airtight structures based on the optimal internal stiffening structure.

16. The method of claim 15, wherein after the curing the assembly, the curable material applied to the outer surfaces of the plurality of hollow airtight structures forms an approximation of the optimal internal stiffening structure based on the load map.

17. The method of claim 1, wherein the composite structure comprises an aerospace component.

18. The method of claim 1, wherein the composite structure comprises a flight control structure.

19. The method of claim 1, wherein the composite structure comprises a spoiler.

20. The method of claim 19, wherein after the curing the assembly, the curable material forms at least one internal rib, a mid spar, a rear spar, and a front spar of the spoiler.

21-22. (canceled)
